(19) United States
(12) Patent Application Publication
(10) Pub. No.: US 2007/0087780 A1
(43) Pub. Date: Apr. 19, 2007

(54) An Adaptive Wireless Headset System

(76) Inventor: Shary Nassimi, Malibu, CA (US)

Correspondence Address: BOND, SCHOENECK & KING, PLLC, ONE LINCOLN CENTER, SYRACUSE, NY, 13202-1355, US

(21) Appl. No.: 11/163,322

(22) Filed: Oct. 14, 2005

(51) Int. Cl. H04M 1/00

(52) U.S. Cl. 455/556.1

(57) ABSTRACT

The present invention is directed to a method for pairing a wireless headset and a dongle. The method includes the step of inserting a headset battery into the wireless headset. The headset is configured to retrieve a headset identification key in response to the headset battery insertion. A dongle battery is inserted into a dongle within a predetermined period of time after inserting the headset battery into the wireless headset. The dongle is configured to retrieve a dongle identification key in response to the dongle battery being inserted. Handshaking transmissions are exchanged between the wireless headset and the dongle, wherein the headset random identification key is combined with the dongle random identification key to form a system verification key, the system verification key being employed by the wireless headset and the dongle to code and decode transmissions between the wireless headset and the dongle.

### BACKGROUND OF THE INVENTION

1. Field of the Invention

The present invention relates generally to wireless technology, and particularly to wireless headset technology.

2. Technical Background

Conventional telephone use requires that the telephone, or telephone receiver, be held against the user's ear during the conversation. This may become tiring during long conversations. In many cases users end up cradling the telephone receiver between the shoulder and their neck to free their hands for other tasks. This may become particularly burdensome in an office environment if the user must spend a large part of his work day on the telephone. This problem may occur in the home environment as well.

In the meantime, the telecommunication infrastructure has been revolutionized by wireless technology. At one time, owning and using a wireless cellular phone might have been considered extravagant for the average user. Now, only a few short years later, wireless mobile telephony is ubiquitous and in many quarters, considered a necessity. For example, many people view driving as relatively unproductive and therefore, view driving time as a perfect opportunity for making a few telephone calls. Wireless technology, for good or for bad, directly enables a user to drive an automobile while conversing with a remote party. On the other hand, driving an automobile while holding a telephone to the ear is both awkward and distracting. Several jurisdictions have banned the use of wireless telephony by drivers because of the number of accidents caused by motorists that were driving while talking. Not only is hands-free telephonic communication desirable in an automotive environment, it is also becoming a necessity in home and office environments as well.

In one approach that has been considered, a hands-free telephony kit allows a user to carry on a conversation without having to hold the wireless phone to his ear. The kit allows the user to perform other tasks with his hands, such as operating a personal computer, writing, doing dishes or laundry, or driving an automobile. A hands-free kit typically includes a cradle that accommodates the wireless telephone. The cradle includes a power supply that may plug into an ordinary outlet or vehicle power outlet, such as a cigarette lighter input. After the user dials the phone number of the party she is trying to reach, or after she receives an incoming call, she will typically place the wireless phone into the cradle. The cradle is configured to provide electrical signals between the telephone and the headset. One of the problems associated with this approach relates to the wireline connection between the headset and the cradle. Although the user enjoys hands free communications, she is still tethered to the cradle. Accordingly, the user's movement is rather restricted.

In another approach, the user wears a wireless headset configured to provide short range wireless communications between the wireless telephone and the headset by way of a “base-station” device. The base station is typically adapted to accommodate a particular phone model or a small number of closely related phones. One of the beneficial functions of the base station is to provide secure wireless communication channel between the headset and the station. However, this arrangement may become problematic if the user replaces the existing telephone with a newer or different model, or if the user changes to a different wireless service provider. Further, compatibility problems arise because newer phones tend to be smaller and shaped differently than older phones. More importantly, the electrical characteristics of the newer phones may be quite different from the older model. As such, the newer telephone may be incompatible with the existing base station.

What is needed is a low cost, small, adaptive wireless headset system that is configured to provide an adaptive wireless interface between any wireless communications device and a wireless headset for unrestricted hands-free communications. The term wireless communications device refers to any wireless telephone model, cordless telephones, or walkie-talkies. The adaptive communications device must be able to mate and re-mate with different wireless headsets on an as needed basis.

### SUMMARY OF THE INVENTION

The present invention addresses the needs described above. In particular, the adaptive dongle of the present invention is an inexpensive, small and unobtrusive adaptive device that is configured to provide a wireless interface between any wireless communications device and a wireless headset for unrestricted hands-free communications. Further, the adaptive dongle of the present invention is configured to mate and re-mate with different wireless communications devices on an as-needed basis.

One aspect of the present invention is directed to a method for pairing a wireless headset and a dongle. The method includes the step of inserting a headset battery into the wireless headset. The headset is configured to retrieve a headset identification key in response to the headset battery insertion. A dongle battery is inserted into a dongle within a predetermined period of time after inserting the headset battery into the wireless headset. The dongle is configured to retrieve a dongle identification key in response to the dongle battery being inserted. Handshaking transmissions are exchanged between the wireless headset and the dongle, wherein the headset random identification key is combined with the dongle random identification key to form a system verification key, the system verification key being employed by the wireless headset and the dongle to code and decode transmissions between the wireless headset and the dongle.

In another aspect, the present invention is directed to a wireless headset system. The system includes a dongle having a connector configured to couple to a wireless communications device. The dongle also includes at least one dongle circuit, a dongle transceiver portion, and a dongle power supply including a dongle battery receptacle unit. The at least one circuit is configured to generate a dongle random identification key in response to a dongle battery being inserted into the dongle battery receptacle unit. The system also includes a wireless headset having at least one headset circuit, a headset transceiver portion, and a headset power supply including a headset battery receptacle unit. The at least one headset circuit is configured to generate a headset random identification key in response to a headset battery being inserted into the headset battery receptacle unit. The headset circuit also is configured to initiate handshaking transmissions with the dongle if the dongle battery is inserted into the battery receptacle unit within a predetermined period of time, whereby the headset random identification key is combined with the dongle random identification key to form a system verification key, the system verification key being employed by the wireless headset and the dongle to code and decode transmissions between the wireless headset and the dongle.

Additional features and advantages of the invention will be set forth in the detailed description which follows, and in part will be readily apparent to those skilled in the art from that description or recognized by practicing the invention as described herein, including the detailed description which follows, the claims, as well as the appended drawings.

It is to be understood that both the foregoing general description and the following detailed description are merely exemplary of the invention, and are intended to provide an overview or framework for understanding the nature and character of the invention as it is claimed. The accompanying drawings are included to provide a further understanding of the invention, and are incorporated in and constitute a part of this specification. The drawings illustrate various embodiments of the invention, and together with the description serve to explain the principles and operation of the invention.

### BRIEF DESCRIPTION OF THE DRAWINGS

FIG. 1 is a diagrammatic depiction of the system in accordance with the present invention;

FIG. 2 is a block diagram of the system depicted in FIG. 1;

FIG. 3 is a flow chart showing a mating protocol for the wireless headset depicted in FIG. 1; and

FIG. 4 is a flow chart showing a mating protocol for the dongle depicted in FIG. 1.

### DETAILED DESCRIPTION

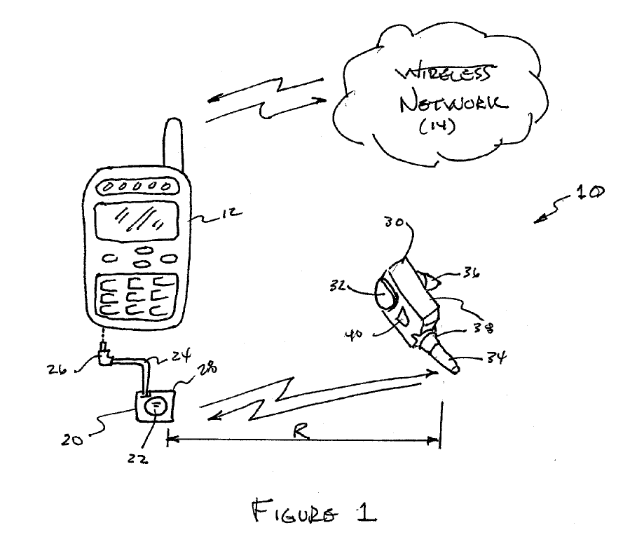

Reference will now be made in detail to the present exemplary embodiments of the invention, examples of which are illustrated in the accompanying drawings. Wherever possible, the same reference numbers will be used throughout the drawings to refer to the same or like parts. An exemplary embodiment of the system of the present invention is shown in FIG. 1, and is designated generally throughout by reference numeral 10.

As embodied herein, and depicted in FIG. 1, a diagrammatic depiction of wireless headset system 10 in accordance with an embodiment of the present invention is shown. System 10 includes a dongle 20 wirelessly coupled to wireless headset 30 by way of a wireless communications channel. Dongle 20 includes a wire 24 coupled to connector 26. Connector 26 is inserted into a jack disposed in wireless communications device (WCD) 12. WCD 12 is engaged in full-duplex communications with a remote user by way of wireless network 14.

Dongle 20 also includes a battery, audio/logic circuitry, RF transceiver, and an antenna (not shown in FIG. 1), which are disposed in housing 28. Access to the battery is provided by battery cover 22. As noted above, dongle 20 is coupled to wireless headset 30 via an RF channel. Dongle 20, of course, functions as a relay between headset 30 and WCD 12. Referring to headset 30, audio is provided to the user via earpiece 36. A user microphone is disposed in sound tube 34. Wireless headset 30 also includes a battery, audio/logic circuitry, RF transceiver, and an antenna (not shown in FIG. 1), which are disposed in housing 38. Access to the battery is provided by battery cover 32. In normal communications mode, the range (R) between wireless headset 30 and dongle 20 may be up to approximately 50 feet.

It will be apparent to those of ordinary skill in the pertinent art that modifications and variations can be made to the wireless communications link between dongle 20 and wireless headset 30 depending on the size and complexity of the RF components and logic circuitry. In one embodiment, dongle 20 and headset 30 are configured to support a 125 channel, 2.4 GHz RF communication channel.

Dongle 20 is approximately one-inch square, approximately the size of a postage stamp. In one embodiment, connector 26 is configured to fit any WCD 12 having a 3-ring, 2.5 mm jack. Those of ordinary skill in the art will also understand that any WCD 12 may be used in conjunction with dongle 20, including wireless or cellular telephones, cordless telephones, or walkie-talkies. Cordless telephones, of course, are often used in business or home environments, and are configured to wirelessly communicate with a base station coupled to the public-switched telephony network (PSTN). In another embodiment, dongle 20 includes a flat attachment plate that is configured to be attached to a flat surface of WCD 12. The attachment plate holds dongle 20 in a secure and unobtrusive position relative to WCD 12. It also prevents dongle 20 from dangling from WCD 12 and possibly becoming caught by some exterior element.

Wireless headset 30 is also relatively small and light weight. For example, in one embodiment, headset 30 is approximately 8 grams. Headset 30 may also include a remote answer button 40 disposed thereon. In other embodiments, headset 30 may be configured to be voice-dialing compatible and include automatic ON/OFF functionality. Wireless headset 30 also includes other features and benefits. For example, earpiece 36 may be formed like an ear-plug to comfortably fit inside the user's ear. In another embodiment, the user may select between eight (8) ear gels to obtain the best fit and maximum comfort level.

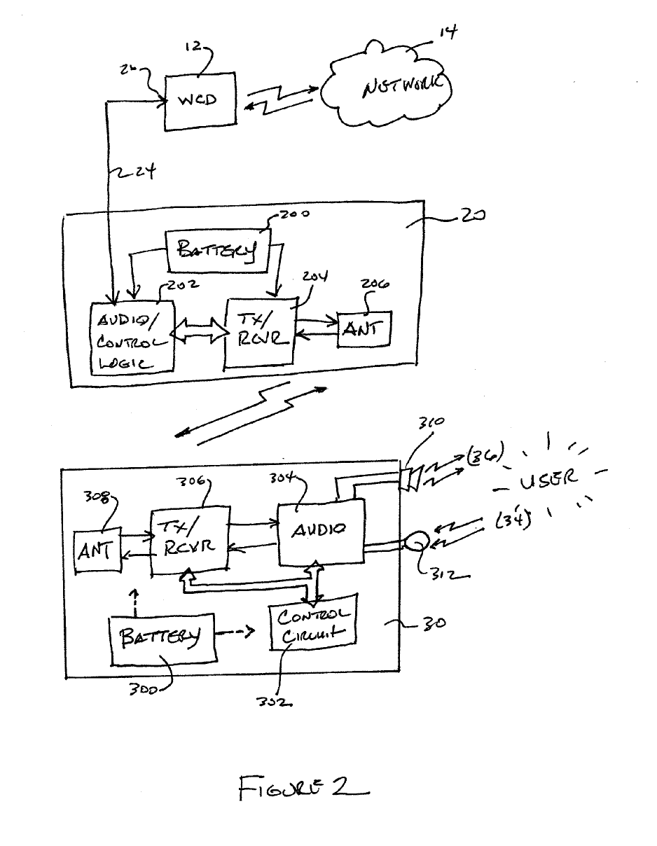

Referring to FIG. 2, a block diagram of the system depicted in FIG. 1 is shown. Dongle 20 includes audio and control logic circuitry 202 coupled to transmitter/receiver 204. The circuitry 202 and the transceiver 204 are powered by battery 200. The audio circuit is configured to establish a full-duplex audio communications channel with WCD 12 over wire 24. An audio signal from WCD 12 is coded using a system verification key such that it may be decoded by headset 30. The coded signal is subsequently directed into transceiver 204. Accordingly, the transceiver modulates and filters the audio signal and directs the RF signal to antenna 206. Antenna 206 transmits the RF signal in an isotropic propagation pattern. Antenna 206 is also configured to receive RF transmissions from antenna 308, which is disposed in headset 30. The receive side of transceiver 204 demodulates the RF signal and provides a base band signal to circuitry 202. At this point, circuitry 202 decodes the signal using the system verification key. The decoded audio signal is transmitted to WCD 12 by way of wire 24. A more complete description of the security key and its implementation is provided below. Suffice it to say for the present that circuitry 202 is configured to generate a dongle random identification key when battery 200 is inserted into the dongle battery receptacle unit. A series of hand shaking steps is performed between dongle 20 and headset 30 to generate the security key. Circuit 202 also provides dongle 20 with various control signals as well.

It will be apparent to those of ordinary skill in the pertinent art that modifications and variations can be made to audio/control circuit depending on the size and complexity of dongle 20. For example, in a miniaturized dongle embodiment, control circuitry 202 may be implemented using application specific integrated circuits specifically designed and miniaturized to be as small as possible. On the other hand, the dongle of the present invention may be disposed in a larger housing 28 if standard off-the-shelf processing circuitry is employed in the implementation.

Referring back to FIG. 2, headset 30 includes a battery configured to provide power to control circuit 302, audio circuitry 304, and transceiver 306. Control circuit 302 is configured to generate a headset random identification key in response to headset battery 300 being inserted into the headset battery receptacle unit 302 (See FIG. 1). After the battery is inserted, circuit 302 attempts to reestablish communications with a previously paired dongle by transmitting one or more RF transmissions to the previously paired dongle. Of course, if the user intends to mate the headset with a new dongle, the programming in circuit 302 will wait for a response from the previous dongle for a predetermined period of time and then transmit an interrogation transmission configured to initiate handshaking with a new dongle. As will be explained below, the headset random identification key is combined with the dongle random identification key to form a system verification key during this procedure. Control circuit 302 also provides audio circuit 304 and transceiver 306 with timing and control signals.

Of course, microphone 312 converts user speech into analog electrical signals corresponding to the user's speech. The audio signals are coded using the system verification key and directed into the transmitter in transceiver 306. The transmitter modulates and filters the coded signal. The RF signal is subsequently directed into antenna 308. Antenna 308 propagates the RF signal.

On the receive side, antenna 308 is also configured to capture RF signals propagating from dongle 20. The receiver in transceiver 308 demodulates the RF signal and provides a base band signal to audio circuit 304. Audio circuit 304 and control circuit 302 decode the signal using the system verification key. The decoded audio is directed into speaker 310 which provides remote user speech to the user. A remote user, of course, is one that is coupled to network 14 and communicating, by way of network 14, to WCD 12.

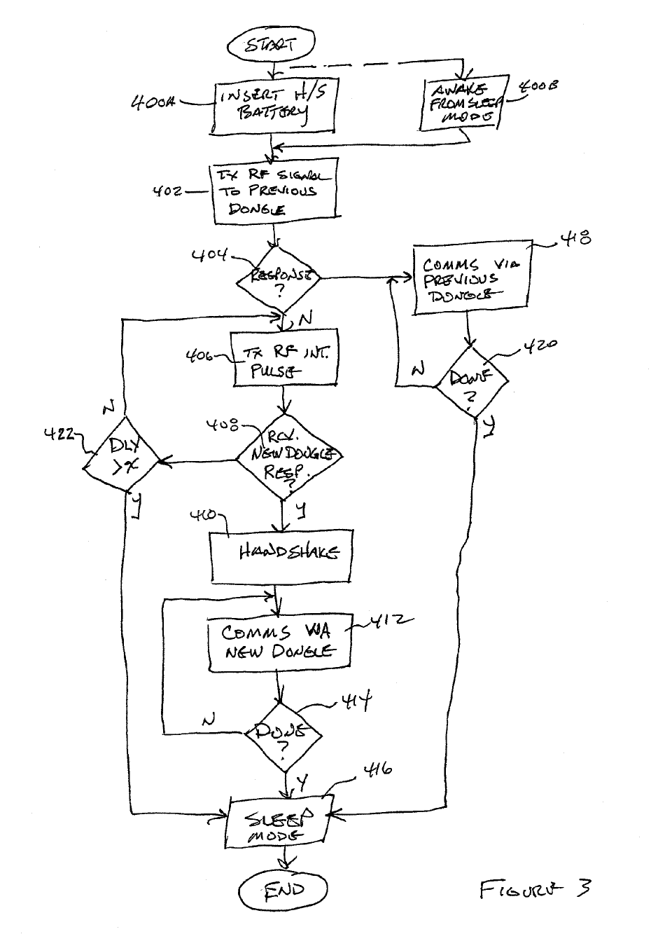

Referring to FIG. 3, a flow chart showing a mating protocol for the wireless headset depicted in FIG. 1 is disclosed. In step 400, a battery is inserted into headset 30. In response, an RF signal is transmitted using a security key that should be recognized by a previously mated dongle. If the previously mated dongle recognizes the signal, communications between headset 30 and the dongle resume. In step 420, the communication session ends and after a period of time elapses, the device 30 goes into sleep mode. In step 404, if the previously mated dongle does not respond, the headset transmits an interrogation pulse. As denoted by step 408 and step 422, headset 30 will attempt to establish communications with a new dongle 20 for a predetermined period of time before reverting back to sleep mode in step 416. In other words, the user must insert a battery into the new dongle within the aforementioned predetermined period of time if the mating procedure is to be successful. Once headset 30 receives a response from new dongle 20, the two devices exchange handshaking communications. Afterwards, in step 412, headset 30 may be coupled to a WCD 12 and thereby establish communications with a remote user in network 14 (See FIG. 1). After the conversation is completed, the user may make another call. Otherwise, headset 30 and dongle 20 go into sleep mode to conserve power.

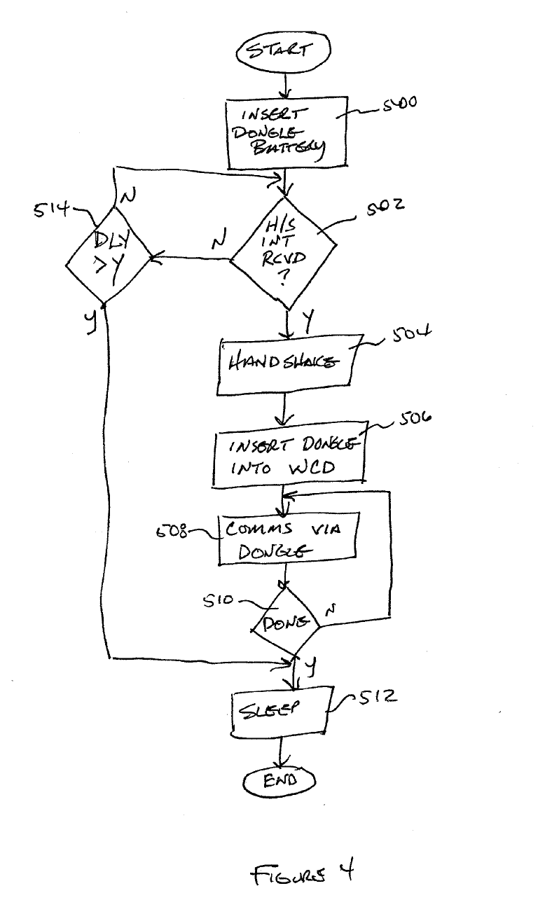

Referring to FIG. 4, a flow chart showing a mating protocol for the dongle depicted in FIG. 1 is disclosed. In step 500, a battery is inserted into dongle 20. Again, as noted above, if the mating procedure is to be successful, the dongle battery must be in place within a certain time frame after the headset battery is disposed in headset 30. In step 502, dongle 20 waits for an interrogation from headset 30. If the dongle is interrogated, handshaking commences. Once the system security key is adopted by both the dongle 20 and headset 30, secure wireless communications may commence between the headset and WCD 12 via dongle 20. After the conversation is complete, dongle programming will direct the dongle into a sleep mode if there is a period of inactivity for a predetermined period of time.

Those of ordinary skill in the art will appreciate that any suitable handshaking method may be employed to implement the present invention. Handshaking includes an authentication procedure for ensuring secure communications between dongle 20 and headset 30. For example, the present invention may employ a unidirectional authentication flow or a bidirectional authentication flow. As those skilled in the art will appreciate, in an unidirectional flow, one device must initiate the authentication. In a bidirectional flow, although one party always initiates the authentication, there is no pre-determined role of initiator and responder. As noted above, each of the dongle 20 and the headset 30 generate their own device authentication key during the authentication process. During handshaking, the devices exchange random device identification keys. A mated security key is generated by combining both random device identification keys in a suitable cryptographic operation. Communications between the dongle 20 and headset 30 are inherently more secure because both device keys are exchanged and protected by the single key.

In yet another embodiment of the present invention, both the dongle 20 and the headset 30 may have a preprogrammed identification key stored in memory. Thus, when the battery is installed in the headset 30, circuit 302 retrieves a preprogrammed headset identification key from memory before attempting the mating and handshaking protocols. Similarly, dongle 20 may be configured to retrieve a preprogrammed dongle identification key after battery insertion.

It will be apparent to those skilled in the art that various modifications and variations can be made to the present invention without departing from the spirit and scope of the invention. Thus, it is intended that the present invention cover the modifications and variations of this invention provided they come within the scope of the appended claims and their equivalents.

What is claimed is:

1. A method for pairing a wireless headset and a dongle, the method comprising:
inserting a headset battery into the wireless headset, the headset being configured to retrieve a headset identification key in response thereto;
inserting a dongle battery into a dongle within a predetermined period of time after inserting the headset battery into the wireless headset, the dongle being configured to retrieve a dongle identification key in response thereto; and
exchanging handshaking transmissions between the wireless headset and the dongle, wherein the headset identification key is combined with the dongle identification key to form a system verification key, the system verification key being employed by the wireless headset and the dongle to code and decode transmissions between the wireless headset and the dongle.

2. The method of claim 1, wherein the wireless headset device is configured to enter a low RF power mode during the predetermined period of time.

3. The method of claim 2, wherein the dongle must be disposed within a predetermined first radius relative to the wireless headset device during the predetermined period of time.

4. The method of claim 2, wherein the wireless headset device is configured to enter a normal RF power mode after the predetermined period of time.

5. The method of claim 4, wherein an effective transmission range between the dongle and the wireless headset in the normal RF power mode is approximately fifty (50) feet.

6. The method of claim 1, further comprising the step of inserting the dongle into a wireless communications device, wireless communications being established between the wireless headset and the wireless communications device via the dongle.

7. The method of claim 1, wherein the wireless headset is configured to enter a sleep mode after the wireless communications are established between the wireless headset and the wireless communications device if there is no wireless communication activity between the wireless headset and the wireless communications device after a second predetermined period of time.

8. The method of claim 7, wherein the wireless headset is configured to attempt to reestablish communications with the dongle after it awakes from sleep mode, the wireless headset being configured to automatically awake from sleep mode in response to user wireless communications activity.

9. The method of claim 7, wherein the wireless communications device is selected from a group comprising a wireless telephone, a cordless telephone, and/or a walkie-talkie.

10. The method of claim 1, wherein the step of exchanging further comprises:
at least one initial RF transmission from the wireless headset to a previously paired dongle;
at least one second interrogation transmission from the wireless headset after a third predetermined period of time has elapsed after the at least one initial transmission without a response from the previously paired dongle, the at least one second interrogation transmission being configured to initiate handshaking with the dongle;
transmitting the dongle identification key from the dongle to the wireless headset in response to the at least one second interrogation transmission; and
transmitting the headset identification key from the wireless headset to the dongle in response thereto.

11. The method of claim 10, wherein the wireless headset and the dongle independently derive the system verification key in accordance with a predetermined algorithm.

12. The method of claim 1, wherein the dongle identification key includes a dongle random identification key and wherein the headset identification key includes a headset random identification key.

13. The method of claim 1, wherein the dongle identification key includes a dongle pre-programmed identification key and wherein the headset identification key includes a headset pre-programmed identification key.

14. A wireless headset system comprising:
a dongle comprising a connector configured to couple to a wireless communications device, the dongle also including at least one dongle circuit, a dongle transceiver portion, and a dongle power supply including a dongle battery receptacle unit, the at least one circuit being configured to retrieve a dongle identification key in response to a dongle battery being inserted into the dongle battery receptacle unit; and
a wireless headset comprising at least one headset circuit, a headset transceiver portion, and a headset power supply including a headset battery receptacle unit, the at least one headset circuit being configured to,
retrieve a headset identification key in response to a headset battery being inserted into the headset battery receptacle unit,
initiate handshaking transmissions with the dongle if the dongle battery is inserted into the battery receptacle unit within a predetermined period of time, whereby the headset random identification key is combined with the dongle random identification key to form a system verification key, the system verification key being employed by the wireless headset and the dongle to code and decode transmissions between the wireless headset and the dongle.

15. The system of claim 14, wherein the at least one headset circuit is selected from a group that includes a microprocessor, an FPGA, and/or an ASIC.

16. The system of claim 14, wherein the at least one headset circuit is configured to drive the wireless headset into a low RF power mode during the predetermined period of time.

17. The system of claim 14, wherein the at least one headset circuit is configured to drive the wireless headset into a normal RF power mode after the predetermined period of time.

18. The system of claim 17, wherein an effective transmission range between the dongle and the wireless headset in the normal RF power mode is approximately fifty (50) feet.

19. The system of claim 14, further comprising the step of inserting the dongle connector into the wireless communications device, wireless communications being established between the wireless headset and the wireless communications device via the dongle, and wherein the wireless communications device is selected from a group comprising a wireless telephone, a cordless telephone, and/or a walkie-talkie.

20. The system of claim 14, wherein the at least one headset circuit is configured to drive the wireless headset into a sleep mode if there is no wireless communication activity between the wireless headset and the wireless communications device after a second predetermined period of time.

21. The system of claim 20, wherein the wireless headset is configured to attempt to reestablish communications with the dongle after it awakes from sleep mode, the wireless headset being configured to automatically awake from sleep mode in response to user activity.

22. The system of claim 14, wherein the at least one headset circuit is further configured to:
transmit at least one initial RF transmission to a previously paired dongle;
transmit at least one second interrogation transmission after a third predetermined period of time has elapsed after the at least one initial transmission without a response from the previously paired dongle, the at least one second interrogation transmission being configured to initiate handshaking with an unknown dongle; and
transmitting the headset random identification key from the wireless headset to the dongle in response to receiving an unknown dongle random identification key from the unknown dongle in response to the at least one second interrogation transmission.

23. The system of claim 14, wherein the dongle identification key includes a dongle random identification key and wherein the headset identification key includes a headset random identification key.

24. The system of claim 14, wherein the dongle identification key includes a dongle pre-programmed identification key and wherein the headset identification key includes a headset pre-programmed identification key.
